(19) United States
(12) Patent Application Publication
(10) Pub. No.: US 2003/0222446 A1
(43) Pub. Date: Dec. 4, 2003

(54) Inflator insertion apparatus and method for airbag systems

(76) Inventors: Quin Soderquist, South Weber, UT (US); Nathan T. Jones, Logan, UT (US); William J. Price, Logan, UT (US)

Correspondence Address: Sally J. Brown, Autoliv ASP, Inc., 3350 Airport Road, Ogden, UT, 84405, US

(21) Appl. No.: 10/157,594

(22) Filed: May 30, 2002

(51) Int. Cl. B60R 21/16

(52) U.S. Cl. 280/743.1

(57) ABSTRACT

Enhanced airbag modules and methods of manufacture are provided. An airbag module according to the invention may have a cushion with an inflator insertion portion through which an inflator can be inserted into the cushion after the cushion has been substantially assembled. The inflator insertion portion may have an elongated opening, which may be oriented generally along a radius of the cushion. The elongated opening may have a comparatively narrow central portion, with first and second ends that may also be narrow, or may be widened for tear restriction and/or venting. All or part of the elongated opening may be covered by a flap that restricts gas flow through the elongated opening during deployment of the cushion.

### BACKGROUND OF THE INVENTION

1. Field of the Invention

The present invention relates to systems and methods for protecting vehicle occupants from injury. More specifically, the present invention relates to openings that facilitate inflator insertion into airbag cushions.

2. Description of Related Art

The inclusion of inflatable safety restraint devices, or airbags, is now a legal requirement for many new vehicles. Airbags are typically installed in the steering wheel and in the dashboard on the passenger side of a car. Additionally, airbags may be installed to inflate beside the passenger to provide side impact protection, in front of the knees to protect the knees from impact, or at other strategic locations.

In the event of an accident, an accelerometer within the vehicle measures the abnormal deceleration and triggers the ignition of an explosive charge. Expanding gases from the charge fill the airbags, which immediately inflate to protect the driver and/or passengers from impact against the interior surfaces of the vehicle. During normal vehicle operation, airbags are typically stowed behind covers to protect them from tampering and provide a more attractive interior facade for the vehicle.

Typically, the expanding gases are expelled into the cushion from an inflator that contains the gas in compressed form or generates gas through the ignition of a pyrotechnic. In certain airbag modules, the inflator is positioned within the cushion. Thus, the inflation gas is able to reach the cushion faster, and installation of the module may be simplified.

Unfortunately, insertion of the inflator into the airbag cushion, according to known methods, adds to the cost and difficulty of the manufacturing process. For example, some known processes require installation of the inflator prior to attachment of the various portions of the cushion. Some processes require that separate portions of the cushion be only partially attached together so that the inflator can be inserted through the unattached portion. The cushion must then be sealed shut with the inflator inside. In either case, the presence of the inflator in the cushion during processing adds to the complexity of the remaining operations.

Other known cushion designs include a hole into which the inflator is to be inserted after the other parts of the cushion have been attached together. Many such holes are oriented or shaped in such a manner that tears are likely to propagate outward from the hole due to the tensile stresses that are present in the cushion during deployment. Some holes are shaped in a manner that is awkward to create through known manufacturing processes. Furthermore, some such holes have a mechanism designed to seal the hole during deployment; however, many such mechanisms are not reliable or predictable in their operation.

Accordingly, a need exists for an airbag module and associated manufacturing method by which an inflator can be inserted into an airbag cushion after all other cushion elements have been fully assembled and attached together. Preferably, the airbag module provides a cushion that is resistant to tearing during deployment, and that reliably inflates with the proper sealing and/or venting characteristics. Furthermore, the airbag module should be inexpensive and easy to manufacture.

### SUMMARY OF THE INVENTION

The apparatus and method of the present invention have been developed in response to the present state of the art, and in particular, in response to the problems and needs in the art that have not yet been fully solved by currently available airbag modules. Thus, it is an overall objective of the present invention to provide an airbag module that remedies the shortcomings of the prior art. Such an airbag module may permit insertion of the inflator into a fully assembled cushion, and may reduce the danger of inadequate cushion sealing or venting during deployment.

To achieve the foregoing objective, and in accordance with the invention as embodied and broadly described herein in the preferred embodiment, an enhanced airbag module is provided. The airbag module may have a cushion and an inflator designed to be seated within the cushion. The cushion may be folded around the inflator to pack the module for installation in a vehicle. According to one exemplary embodiment, the airbag module is a front impact airbag module designed to protect the upper body of a passenger from forward impact.

The cushion may have a front panel designed to receive impact from the vehicle occupant, and a rear panel that faces toward the dash board or steering wheel when the cushion deploys. The panels may be generally circular in shape, and may be attached at their outer edges. The panels may cooperate to form an insertion passageway that can be sealed after the remainder of the panel edges have been attached together.

If desired, the cushion may include a tether disposed within the cushion to attach the first and second panels together toward the center of the cushion, so that expansion of the cushion toward the vehicle occupant is limited. The tether may include a first tether portion attached to the first cushion and a second tether portion attached to the second cushion. Each of the tether portions may have an attachment flap, so that the tether portions can be attached together to form a complete loop.

The rear panel may also have one or more vents designed to permit gas to escape from the cushion at a measured rate. Each of the vents may include a hole in the rear panel. The hole may be surrounded by one or more reinforcement discs of fabric material that reduce the probability of tearing from the vents.

Furthermore, the rear panel may have an inflator insertion portion designed to permit insertion of the inflator through the rear panel. The inflator insertion portion may have an elongated opening. According to one embodiment, the elongated opening is fully covered by a flap attached around the elongated opening on three sides to create a pocket. The side furthest from the center of the cushion may be left open, so that the inflator may be inserted through the elongated opening, removed from the pocket by moving the inflator away from the center of the cushion, and then moved to its final position at the center of the cushion.

The rear panel may have a projection designed to fit through an inflator attachment aperture in the center of the rear panel. The inflator may be retained in place through the use of anchoring arms extending from the projection, or through another suitable anchoring mechanism. Hence, after removal from the inflator insertion portion, the inflator may be moved into alignment with the inflator attachment aperture, and the projection may be inserted through the aperture and retained in place.

The elongated opening may be very narrow, so as to essentially form a slit. The elongated opening may even be formed by cutting a straight line in a single direction of the cushion, so that the two sides of the elongated opening lie flush with each other when the cushion is flat. The elongated opening may be oriented generally in-line with the center of the rear panel, so that stresses radiating outward from the center do not tend to induce tearing of the cushion outward from the elongated opening.

The length of the elongated opening may be just large enough to enable comparatively easy manual insertion of the inflator. The flap may entirely cover the elongated opening, with an overlap sufficient to substantially seal the elongated opening during deployment of the cushion.

According to another embodiment of the invention, the elongated opening may be disposed at some angle with respect to an intersecting radius of the rear panel. The elongated opening may thus be neither parallel nor perpendicular to the radius. The elongated opening may have a thin central portion, with a first end and a second end that are somewhat wider than the central portion. Each of the first and second ends may even have a circular shape to further prevent tear propagation from the ends of the elongated opening.

In another embodiment, the elongated opening may extend beyond the flap so as to provide venting of the gas within the cushion. Hence, separate vents need not be provided. If desired, the first end of the elongated opening may extend beyond the edge of the flap, and may have a circular shape large enough to provide the desired mass flow rate of gas from the cushion during deployment. The remainder of the elongated opening, i.e., the central portion and the second end, may be comparatively thin, and may be covered by the flap. Thus, the elongated opening is still long enough to receive the inflator, but a portion of the elongated opening is covered during deployment to prevent excess venting.

In yet another embodiment, both first and second ends of the elongated opening extend from the flap to provide venting. Thus, both ends may have wide, circular shapes, while the central portion is thin. The central portion may be covered by the flap. If desired, the flap may be attached through the central portion. Hence, the central portion may, exclusively, be used for inflator insertion, while the first and second ends simply provide venting.

According to another embodiment, the flap may be omitted entirely, so that the full length of the elongated opening is used for both inflator insertion and venting. The first and second ends may thus have wide circular shapes, as with the previous embodiment. The central portion may remain thin. The wide shape of the first and second ends also serves to prevent tearing; hence, the elongated opening may be oriented perpendicular to the radius. Venting may be expected to occur through the first and second ends, and also through the central portion, which may open somewhat during deployment of the cushion to release gas.

In still another embodiment, the flap may once again be omitted. The elongated opening may have first and second ends with a somewhat smaller circular configuration. The elongated opening may be disposed parallel to the radius. In this embodiment, the central portion is once again narrow, and provides the majority of the venting area. The first and second ends restrain tear propagation, but are not large enough to serve as vents without gas flow through the central portion. Reinforcement seams may be disposed around three sides of each of the first and second ends to further restrict the propagation of any tears originating at the elongated opening.

According to one exemplary manufacturing process, the airbag module may be manufactured through a number of steps. The front and rear panels may first be provided by cutting them into the desired shape. The rear panel may further be cut to form the elongated opening, the vents (if used), and the inflator attachment opening. The flap may be attached to the rear panel, over the elongated opening. The first and second tether portions may then be attached to the first and second panels, respectively.

The panels may then be attached together at their outer edges, with the exception of the insertion passageway. The panels may be attached with the internal components on the outside, i.e., with the flap, tether portions, and reinforcement elements attached to the outside of the rear panel. The first and second tether portions may then be attached together. The cushion may then be turned inside out by pushing the panels, the flap, and the tether through the insertion passageway, after which the insertion passageway may be sewn shut. In the alternative, the panels may initially be fully attached in such a manner that the insertion passageway is omitted; the cushion may then be turned inside out via the inflator attachment opening.

The inflator may then be inserted into the cushion through the elongated opening. The inflator may be maneuvered into alignment with the inflator attachment opening. Such maneuvering may entail moving the inflator out of the pocket formed by the flap, and then moving the inflator toward the inflator attachment opening. The projection of the inflator may be inserted through the inflator attachment opening and anchored in place. The cushion may then be folded around the inflator to provide a compact module that is ready for installation in a vehicle.

Through the use of the airbag modules and associated manufacturing methods of the present invention, airbags may be produced in a more convenient and cost-effective manner. Furthermore, such airbag modules may provide more reliable gas retention and/or venting characteristics. Additionally, the cushions provided by the present invention may have a lower likelihood of failure due to tearing of the cushion material.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a cutaway, perspective view of one embodiment of an airbag module within the scope of the invention;

FIG. 2 is a side elevation, section view of the airbag module of FIG. 1;

FIG. 3 is a front elevation view of the inflator insertion portion of the airbag module of FIGS. 1 and 2;

FIG. 4 is a front elevation view of the inflator insertion portion of an airbag module according to an alternative embodiment of the invention;

FIG. 5 is a front elevation view of an inflator insertion portion of an airbag module according to another alternative embodiment of the invention;

FIG. 6 is a front elevation view of an inflator insertion portion of an airbag module according to another alternative embodiment of the invention;

FIG. 7 is a front elevation view of an inflator insertion portion of an airbag module according to yet another alternative embodiment of the invention; and

FIG. 8 is a front elevation view of an inflator insertion portion of an airbag module according to still another alternative embodiment of the invention.

### DETAILED DESCRIPTION OF THE PREFERRED EMBODIMENTS

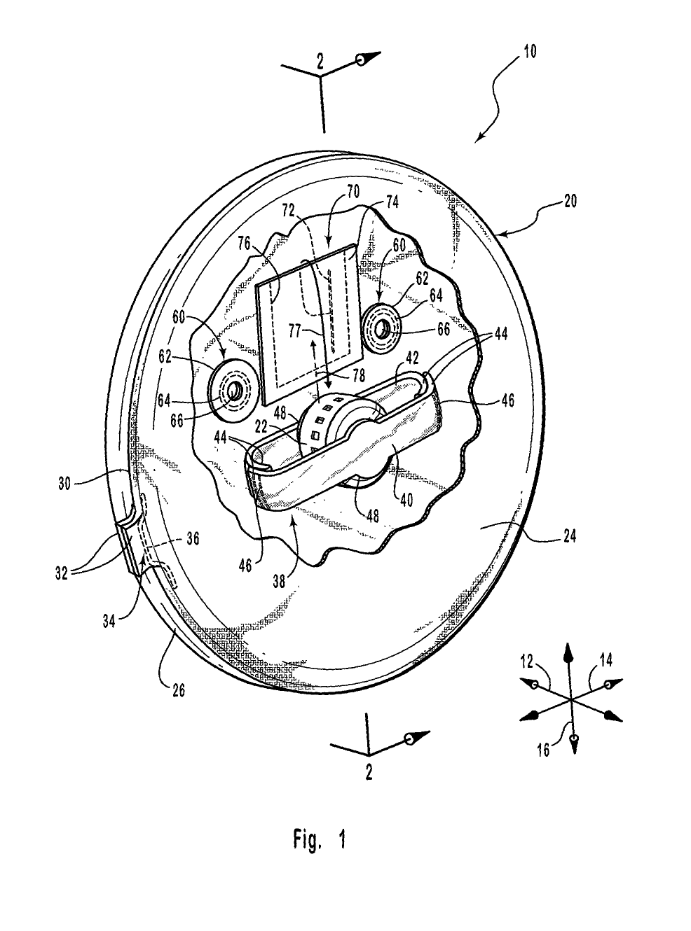

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 8, is not intended to limit the scope of the invention, as claimed, but is merely representative of presently preferred embodiments of the invention.

The present invention utilizes a number of physical principles to enhance the cost-effectiveness and operation of airbag modules. For example, crack and tear propagation have the greatest tendency to originate from an opening that is disposed perpendicular to the direction along which tensile stress is greatest. Tears propagate more readily from openings with narrow ends than from those with enlarged ends.

Furthermore, air flow through an opening will generally be proportional to the size of the area encompassed by the opening. In the case of flexible materials such as fabric, deformation of the opening due to tensile and bending stresses may tend to increase the size of the opening, thereby permitting significant gas flow through an otherwise narrow opening. Additionally, some flexible materials may be used to substantially seal an opening by ensuring that the flexible material overlaps the opening by a sufficient distance. In general, a larger overlap produces a better seal.

Such principles may be applied to many types of airbags, including driver's side airbags, passenger's side airbags, overhead airbags, knee bolsters and inflatable curtains. The manner in which the present invention utilizes these principles to provide cost-effective, reliable impact protection will be shown and described in greater detail with reference to FIGS. 1 through 8.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “attached directly to” refers to a form of attachment by which the attached items are either in direct contact, or are only separated by a single fastener, adhesive, or other attachment mechanism. The term “abutting” refers to items that are in direct physical contact with each other, although the items may not be attached together.

Referring to FIG. 1, a cutaway, perspective view shows one embodiment of an airbag module 10 within the scope of the present invention. The airbag module 10 is depicted in fully assembled, deployed form. The airbag module 10 of FIG. 1 is of a type that protects the upper body of a vehicle occupant from forward impact. However, those of skill in the art will recognize that the present invention is equally applicable to other types of airbags, such as knee bolsters, overhead airbags, and inflatable curtains. The airbag module 10 may have a longitudinal direction 12, a lateral direction 14, and a transverse direction 16.

The airbag module 10 may include a cushion 20 and an inflator 22. The cushion 20 may have a generally circular shape when laid flat. The inflator 22 may be disc-shaped, and may be configured to expel inflation gases radially into the cushion 20. The cushion 20 may have a first panel 24 and a second panel 26. The first panel 24 is a “front” panel, i.e., a panel facing the vehicle occupant to receive impact. The second panel 26 is a “rear” panel that faces the dashboard (not shown) or steering wheel (not shown) of the vehicle.

Each of the panels 24, 26 may have an outer edge 30 with a generally circular shape. The outer edges 30 may be attached together in gastight fashion, i.e., so that significant quantities of gas are unable to escape between the outer edges 30 during deployment of the cushion 20. Each of the outer edges 30 may have an extension 32 that protrudes outward. The extensions 32 may cooperate to define an insertion passageway 34, which may simply be a region in which the outer edges 30 are attached together through the use of a separate operation subsequent to that used to attach the remainder of the outer edges 30. The insertion passageway 34 may thus be sealed shut by a seam 36 when the cushion 20 is in its fully assembled state. The purpose and operation of the insertion passageway 34 will be described in greater detail subsequently.

The cushion 20 may also have a tether 38 designed to limit the longitudinal distance between the first and second panels 24, 26. The purpose of the tether 38 is to define the deployed shape of the cushion 20 to ensure that the cushion 20 does not inflate too far toward the vehicle occupant, thereby intensifying the impact of the occupant against the cushion 20. Of course, the tether 38 is optional, and may not be present in every embodiment of the invention.

The tether 38 may include a first tether portion 40 and a second tether portion 42. The first and second tether portions 40, 42 may each have a pair of attachment flaps 44; the attachment flaps 44 of the first tether portion 40 may be attached to those of the second tether portion 42 via seams 46, which may be sewn in place. Alternatively, the seams 46 may be replaced with different forms of attachment such as thermal welds, RF welds, ultrasonic welds, adhesives, or the like. The first and second tether portions 40, 42 may be attached to the centers of the first and second cushions 24, 26, respectively, via attachment portions 48. Each attachment portion 48 may have a circular shape, and may be sewn to the corresponding panel 24 or 26.

The second panel 26, or rear panel, may also have one or more vents 60 that permit the escape of a measured quantity of inflation gas during deployment and impact of the occupant against the first panel 24. Since stresses tend to concentrate at the edges of holes, each of the vents 60 may have some type of reinforcement structure designed to ensure that the tears are unable to propagate through the material of the second panel 26 from the vents 60. For example, each of the vents 60 may have a reinforcement disc 62 attached by a sew line 64 to the second panel 26. Each of the reinforcement discs 62 may simply take the form of a circular, fabric sheet.

Holes 66 may extend through the reinforcement disc 62 as well as the material of the second panel 26. The holes 66 may provide an open area sized to release gas rapidly enough to cushion the impact of the occupant against the airbag, but not so rapidly that the occupant strikes the steering wheel or dashboard through the cushion 20. According to one embodiment, the holes 66 may each have a diameter of about thirty millimeters.

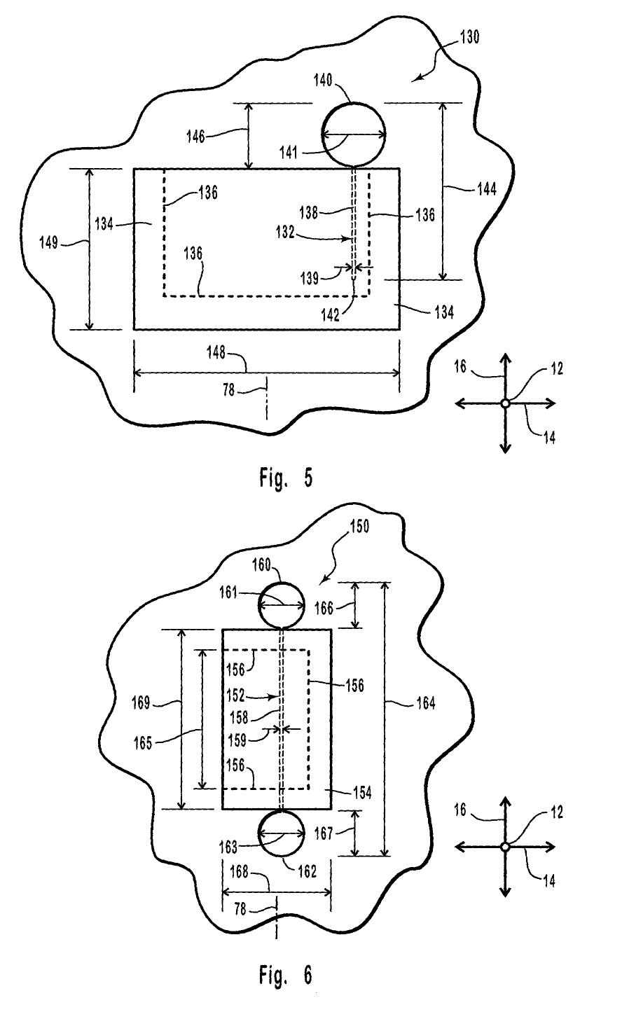

Of course, the vents 60 are optional. In certain embodiments, the cushion may inflate in such a manner that venting is not necessary or desirable. In other embodiments, the cushion may have a somewhat permeable construction so that venting occurs directly through the first and second panels 24, 26. In still other embodiments, venting may occur through an opening that permits passage of the inflator 22 in the cushion 20. Such dual purpose openings will be shown and described subsequently, with reference to FIGS. 5 through 8.

The second panel 26 may have an inflator insertion portion 70, through which the inflator 22 can be inserted into the cushion 20. The inflator insertion portion 70 may have an elongated opening 72 covered by a flap 74. The flap 74 may be attached to the inside of the second panel 26 by attachment lines 76, which may be formed by sewing, adhesive bonding, RF welding, thermal welding, or the like. The attachment lines 76 may be disposed on three sides of the elongated opening 72, so that only the side of the flap 74 furthest from the center of the second panel 26 is open to the interior of the cushion 20. Thus, the attachment lines 76 may form a pocket that contains the elongated opening 72.

Hence, the inflator 22 may be inserted into the cushion 20 along an insertion pathway indicated by the arrow 77. As shown, the elongated opening 72 may be oriented radially, or generally parallel to a radius 78 of the second panel 26 that intersects or nearly intersects the elongated opening 72. Thus, the inflator 22 may be inserted in a direction generally perpendicular to the radius 78, moved toward the edge 30 of the second panel 26 to remove the inflator 22 from the pocket created by the panel 74, and then moved to the center of the second panel 26 for anchoring.

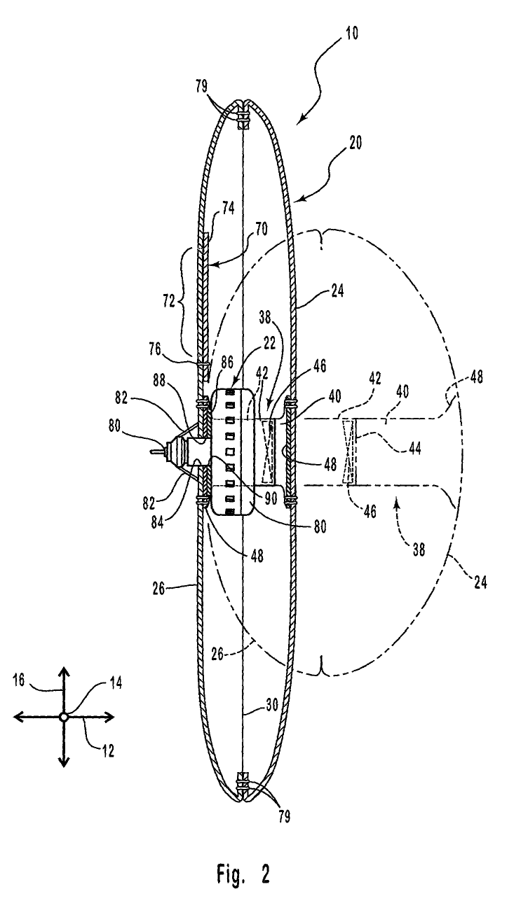

Referring to FIG. 2, a side elevation, section view illustrates the airbag module 10. The airbag module 10 may have seam 79 that attaches the outer edges 30 of the panels 24, 26 to each other. The seam 79 may be formed through sewing, one piece weaving, RF welding, ultrasonic welding, adhesive bonding, chemical bonding, or any other known method. As shown, the seam 79 is sewn. The seam 79 may be formed in such a manner that the outer edges 30 are turned inward against each other, as depicted in FIG. 2. One possible method of forming the seams 79 with such an inward disposition will be described subsequently.

The inflator 22 may be designed to help anchor the cushion 20 in place within the vehicle; this may be accomplished with or without extra plates or other attachments. The inflator 22 may have a projection 80 that extends longitudinally, rearward of the main body of the inflator 22. The projection 80 may have a plurality of anchoring arms 82 designed to keep the inflator 22 in position against the second panel 26. The anchoring arms 82 may, for example, deflect to permit passage of the projection 80 into an opening, after which the anchoring arms 82 extend outward to preclude retraction of the projection 80 through the opening. Of course, other anchoring devices, such as crimped extensions, 11 threaded fasteners, or the like may be used in addition to or in place of the anchoring arms 82.

The rear panel 26 may have an inflator attachment aperture 84 sized to receive the projection 80. If desired, the inflator attachment aperture 84 may be reinforced against tearing through the use of a reinforcement disc 86 disposed between the main body of the inflator 22 and the attachment portion 48 of the second tether portion 42. The reinforcement disc 86 may simply take the form of a circular piece of sturdy fabric. Of course, the reinforcement disc 86 is optional; the same function may additionally or alternatively be performed by the attachment portion 48 of the second tether portion 42.

If desired, the inflator attachment aperture 84 may be sized to perform the same function as the insertion passageway 34. With such a configuration, the panels 24, 26 may be pushed through the inflator attachment aperture 84 to turn the cushion 20 inside out. The insertion passageway 84 may then be omitted entirely, and the outer edges 30 of the panels 24, 26 may initially be sewn together along their entire length.

The attachment portion 48 of the second tether portion 42 and the reinforcement disc 86 may be attached to the second panel 26, around the inflator attachment aperture 84, by sewing, one-piece weaving, RF welding, ultrasonic welding, chemical bonding, adhesive bonding, or any other suitable method known in the art. The attachment portion 48 and the reinforcement disc 86 may have apertures 88, 90, respectively, with the same size and alignment as the inflator attachment aperture 84, to permit passage of the projection 80.

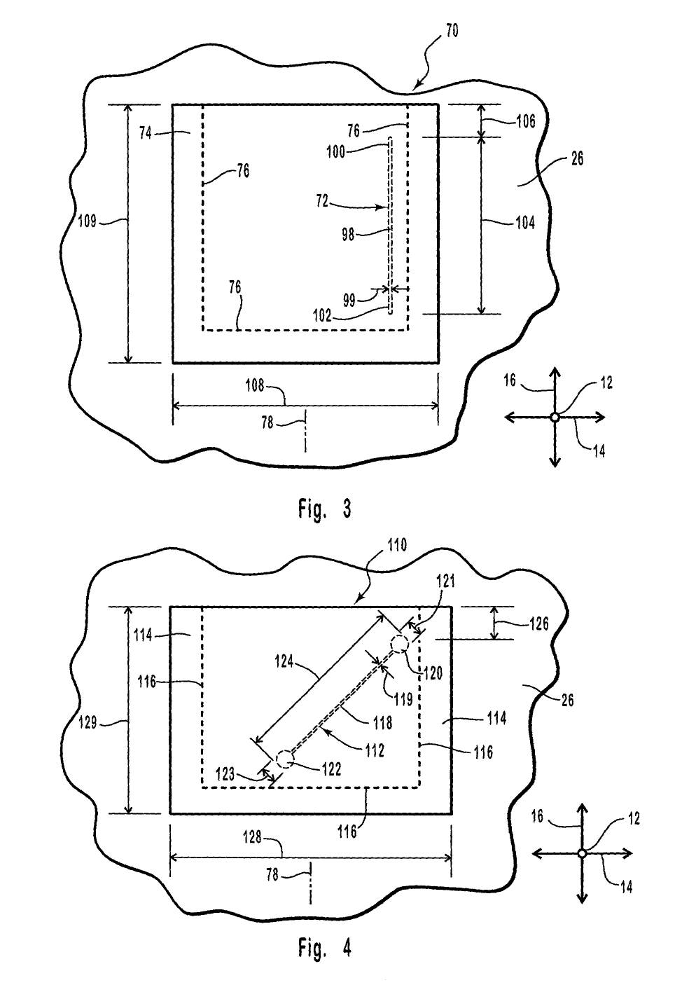

The elongated opening 72 is shown in phantom; as depicted, the elongated opening 72 may extend through the second panel 26 to permit insertion of the inflator 22 through the second panel 26. The inflator insertion portion 70 may be configured in a large number of ways, and may be adapted to suit many different cushion designs. The inflator insertion portion 70 of FIGS. 1 and 2 will be shown and described in greater detail in FIG. 3; FIGS. 4 through 8 present several alternative inflator insertion portion configurations. The configurations presented are only examples; many additional embodiments may be implemented through the application of the principles of the present invention.

Referring to FIG. 3, a plan view illustrates the inflator insertion portion 70 of FIGS. 1 and 2. As mentioned previously, the inflator insertion portion 70 includes the elongated opening 72, formed in the rear panel 26, and the flap 74, which is attached on three sides of the elongated opening 72 by the attachment lines 76. The flap 74 may be constructed of a fabric material, such as that used to form the panels 24, 26. The attachment lines 76 may thus take the form of stitching, welded interfaces, bonded interfaces, or the like. As shown in FIG. 3, the attachment lines 76 are formed by stitching.

In the alternative to the configuration shown, the attachment lines 76 may form a “V” shape rather than the “U” shape shown in FIG. 3, and still surround the elongated opening 72 on three sides. The attachment lines 76 also include curved shapes such as semicircles, partial ellipses, or the like. The attachment lines 76 also need not be open on the side furthest from the inflator attachment aperture 84, but may instead be open on either lateral side. However, it may be beneficial to leave the side of the flap 74 nearest the inflator attachment aperture 84 affixed to the second panel 26 because inflation gas flowing from the inflator 22 may otherwise flow directly into the gap between the flap 74 and the second panel 26 during inflation.

The elongated opening 72 may have a central portion 98 with a comparatively small width 99. Additionally, the elongated opening 72 may have a first end 100 and a second end 102 disposed on either side of the central portion 98. The first and second ends 100, 102 may each have width equal to the central portion 98, so that the entire elongated opening 72 has a substantially uniform width 99.

The width 99 may be small enough that the central portion 98, and indeed the entire elongated opening 72, takes the form of a slit. A “slit” may be defined as an opening with a width small enough to be formed with a cutting motion that moves only one way, along the length of the opening. Hence, a circuitous incision, in which the end of the incision intersects the beginning, need not be made. Slits are, therefore, generally easier to form than openings with significant width.

A slit may not have a width of zero, because a flexible material may bend or contract around the edges of the cut. Hence, the central portion 98 may, for example, have a width of less than five millimeters when the cushion 20 is laid flat. Further, the central portion 98 may have a width of less than two millimeters. Yet further, if the fabric of the second panel 26 is somewhat inelastic, the central portion 98 may have a negligible width, so that opposite edges of the central portion 98 lie flush with each other when the cushion 20 is laid flat.

Thus, the elongated opening 72 may be formed relatively easily by slicing the second panel 26 with one single, linear motion. Of course, the elongated opening 72 need not be performed through a mechanical cutting operation. Lasers, reactive chemicals, or other devices that are able to form an incision may also be used.

The elongated opening 72 may have a length 104 selected to permit relatively easy passage of the inflator 22. More specifically, the length 104 may be selected such that the perimeter of the elongated opening 72 is slightly larger than the largest cross section of the inflator 22 that must pass through the elongated opening 72.

For example, with the short, cylindrical shape of the inflator 22 depicted in FIGS. 1 and 2, the inflator 22 may most easily pass through the elongated opening 72 if the flat faces on the top and bottom of the inflator 22 are oriented generally perpendicular to the second panel 26 during insertion. Thus, the elongated opening 72 should be slightly longer than the height of the inflator 22 plus the diameter of the inflator 22. Some additional length may be needed to ensure that the elongated opening 72 is large enough to permit passage of the projection 80.

Of course, other inflator shapes may be used, and the length of the elongated opening 72 may be similarly adapted to ensure that the elongated opening is able to open enough to receive the inflator. If desired, the length 104 may be further increased to permit an operator to grip the inflator 22 and insert the inflator 22 into the opening 72 without releasing the grip. The operator may then insert the inflator 22 through the second panel 26 and maneuver the inflator 22 into engagement with the inflator attachment aperture 84 with one continuous motion, without letting go of the inflator 22.

In the embodiment shown, the length 104 may range from about 70 to about 200 millimeters. Furthermore, the length 104 may range from about 90 to about 150 millimeters. Yet further, the length 104 may be about 110 millimeters.

The flap 74 may be positioned and dimensioned in such a manner that the elongated opening 72 is fully covered by the flap 74, with an overlap 106. The overlap 106 may be selected such that the area of the pocket outside the first end 100 of the elongated opening 72 is large enough to form a substantially gastight seal. When the airbag module 10 deploys, the high pressure within the cushion 20 presses the flap 74 against the elongated opening 72. The pressure tends to form a seal between the flap 74 and the second flap 26; the integrity of the seal is proportional to the pressure and the area of the fabric surfaces that are pressed against each other.

Hence, the overlap 106 can be lengthened to reduce the likelihood that gas will escape through the elongated opening 72 during deployment. Alternatively, the overlap 106 can be shortened to permit some gas to escape or to reduce the amount of material required to form the flap 74. In the embodiment shown in FIG. 3, the overlap 106 may range from about five millimeters to about fifty millimeters. Further, the overlap 106 may range from about ten millimeters to about thirty-five millimeters. Yet further, the overlap 106 may be about twenty millimeters.

The flap 74 may generally be dimensioned such that the flap 74 is large enough to cover the elongated opening 72 and provide the overlap 106, yet not large enough to waste significant material or add excessively to the weight or volume of the airbag module 10. The flap 74 may have a width 108 sufficient to provide the desired amount of inflator maneuvering room within the pocket created by the flap 74. According to one example, the width 108 may be about 160 millimeters. A height 109 of the flap 74 may also be about 160 millimeters.

As mentioned previously, the elongated opening 72 is nearly aligned with the radius 78 that extends outward from the inflator attachment aperture 84, parallel to the elongated opening 72. When the inflator 22 deploys, pressurized gas forces the cushion 20 to expand. Hence, the maximum tensile stress on the fabric of the cushion 20 is typically directed radially, i.e., along lines running from the inflator attachment aperture 84 to the outer edge 30. Hence, at the inflator insertion portion 70, the greatest tensile stress on the material of the second panel 26 runs generally parallel to the radius 78.

Orienting the elongated opening 72 generally parallel to the radius 78 ensures that the greatest tensile stress on the elongated opening 72 does not tend to widen the opening, but rather tends to elongate the opening 72. Hence, crack propagation is less likely to occur than if the elongated opening 72 were disposed at a different orientation. Orienting the elongated opening 72 perpendicular to the radius 78 would generally be the least favorable alternative because the maximum tensile stress would tend to directly widen the opening 72, thereby causing tears to propagate through the second panel 26 from the ends of the elongated opening 72.

The airbag module 10 may be relatively easily manufactured. According to one manufacturing method, the panels 24, 26 may first be formed, for example, by cutting circular shapes from a larger sheet of fabric. The elongated opening 72, the holes 66 of the vents 60, and the inflator attachment aperture 84 may then be formed in the second panel 26, for example, by cutting the desired shapes in the fabric of the second panel 26 with a die, laser, or mechanized blade.

The flap 74 may then be affixed to the inflator insertion portion 70, for example, by sewing the flap 74 in place to form the attachment lines 76. Similarly, the attachment portions 48 of the first and second tether portions 40, 42 may be attached to the centers of the first and second panels 24, 26, respectively. Again, sewing may be used to provide the attachment, although many alternative forms of attachment may also be used.

After the flap 74 and the first and second tether portions 40, 42 have been attached to the panels 24, 26, the panels 24, 26 may be aligned with each other, back-to-back (i.e., with the outer surfaces facing each other). The panels 24, 26 may then be attached together at the outer edges 30. Sewing may be used to form the seam 79. The seam 79 may extend around all but a small length of the outer edges 30 to leave the insertion passageway 34 open.

The attachment flaps 44 of the tether portions 40, 42 may be aligned with each other and attached together, for example, by sewing. The panels 24, 26 may then be pushed through the insertion passageway 34, together with the flap 74 and the attached tether 38, to turn the cushion 20 inside-out. The edges 30 of the cushion panels 24, 26 then obtain the inward orientation depicted in FIG. 2. The insertion passageway 34 may then be closed, for example, through sewing to form the seam 36, thereby ensuring that significant quantities of gas are unable to escape the cushion 20 through the insertion passageway 34 during deployment.

After the cushion 20 has been fully formed, in the manner described above, the inflator 22 may be inserted into the cushion 20. More specifically, as described previously, the inflator 22 may be inserted through the elongated opening 72, into the pocket created by attachment of the flap 74 to the second panel 26. The inflator 22 may then be moved toward the outer edge 30 to remove the inflator 22 from the pocket so that the inflator 22 can be freely moved within the interior of the cushion 20.

The inflator 22 may then be maneuvered to the center of the second panel 26, so that the projection 80 is aligned with the inflator attachment aperture 84. The inflator 22 may then be moved toward the second panel 26 so that the projection 80 extends through the aperture 88 of the attachment portion 48 of the second tether portion 42, the aperture 90 of the reinforcement disc 86, if used, and the inflator attachment aperture 84 of the second panel 26.

Once the projection 80 has been fully inserted, the anchoring arms 82 may extend outward to fix the position of the projection 80 relative to the inflator attachment aperture 84, thereby keeping the inflator 22 properly positioned within the cushion 20. The cushion 20 may then be folded around the inflator 22 to form a compact module that is ready for rapid installation in a vehicle.

The elongated opening 72 may also be used to facilitate insertion of other internal components of the cushion 20, such as heat shields, module attachment features, and the like. The configuration of the elongated opening 72, and of the inflator insertion portion 70 in general, may be adjusted to enable convenient passage of such components.

Of course, the manufacturing method described above is only one of many possible methods that may be used to form the airbag module 10. Furthermore, the system and method of the present invention may be used with a wide variety of cushion types. In addition to front impact airbags, side impact airbags, or “inflatable curtains,” knee bolsters, and overhead airbags may incorporate an inflator insertion portion designed to permit installation of an inflator within the cushion after the cushion has been substantially assembled. Such inflator insertion portions may be configured in a manner similar to the inflator insertion portion 70 described above, or like the inflator insertion portions that will be shown and described in connection with FIGS. 4 through 8.

Referring to FIG. 4, a plan view illustrates an alternative embodiment of an inflator insertion portion 110. The inflator insertion portion 110 may be used with a cushion similar to the cushion 20 of FIGS. 1 and 2, or with a wide variety of other cushion types, as mentioned previously. For the sake of description, FIGS. 4 through 8 assume that a cushion like the cushion 20 of FIGS. 1 and 2 is used.

The inflator insertion portion 110 may have an elongated opening 112 oriented at some angle with respect to the radius 78. The angle may be non-parallel, yet non-perpendicular to the radius 78. Hence, the elongated opening 112 may be oriented in a direction that is neither the most nor the least effective for resisting tear propagation.

The angle of the elongated opening 112 may facilitate insertion of the inflator 22 by simplifying the insertion pathway. More specifically, the insertion pathway 77 of the previous embodiment requires motion of the inflator 22 perpendicular to the radius 78 to enter the elongated opening 72, and then parallel to the radius 78 to remove the inflator 22 from the pocket created by the flap 74. The insertion pathway of the elongated opening 112 has no right angle, and therefore provides for insertion and anchoring of the inflator 22 with a more continuous motion.

A flap 114 may be attached to the second panel 26 via attachment lines 116 to cover the elongated opening 112. Like the flap 74, the flap 114 may be formed from a piece of fabric material. The elongated opening 112 may have a central portion 118 with a width 119 narrow enough to form a slit, like the central portion 98 of the previous embodiment.

However, the elongated opening 112 may also have a first end 120 with a width 121 somewhat larger than the width 119, and a second end 122 with a width 123 approximately equal to the width 121 of the first end 120. The first and second ends 120, 122 may each have a generally circular configuration so that the widths 121, 123 are diameters of the circles. The enlargement of the first and second ends 120, 122 facilitates spreading of the elongated opening 112 for insertion of the inflator 22 and restricts tear propagation from the first and second ends 120, 122.

More specifically, cracks, tears, or narrow openings tend to spread more easily under stress when their tips are comparatively sharp, because the sharpened tip is a location at which stresses gather to continually cause further tearing. The circular shape of the first and second ends 120, 122 spreads the tensile stresses to substantially prevent tear propagation from the first and second ends 120, 122.

Of course, the widths 121, 123 of the first and second ends 120, 122 need not be equal. Rather, the widths 121, 123 may be made different to provide different manufacturing or tear resistance characteristics.

The elongated opening 112 may have a length 124 selected to permit passage of the inflator 22 through the elongated opening 112. As with the previous embodiment, the length 124 may be selected such that the circumference of the elongated opening 112 is larger than that of the largest cross section of the inflator 22 that must pass through the opening 112. Like the elongated opening 72 of the previous embodiment, the length 124 of the elongated opening 112 may be about 110 millimeters.

The flap 114 may be positioned to fully cover the elongated opening 112, with an offset 126 large enough to substantially seal the elongated opening 112 against the escape of pressurized gas during inflation. As with the previous embodiment, the offset 126 may be about twenty millimeters. The flap 114 may also have a width 128 and a height 129 that are selected such that the pocket created by the flap 114 and the second panel 26 is large enough to avoid obstructing the insertion pathway of the inflator 22. According to one example, the width 128 may be about 180 millimeters, and the height may be about 130 millimeters.

Referring to FIG. 5, a plan view illustrates another alternative embodiment of an inflator insertion portion 130 according to the present invention. The inflator insertion portion 130 may have an elongated opening 132 that performs a dual function. More specifically, the elongated opening 132 may be only partially covered by a flap 134 attached to the second panel 26 by attachment lines 136. Hence, the elongated opening 132 may permit passage of the inflator 22 into the cushion 20, and may also serve as a vent for the cushion 20.

The elongated opening 132 may have a central portion 138 with a width 139 small enough to form a slit. Additionally, the elongated opening 132 may have a first end 140 with a width 141 large enough to not only restrain tear propagation, but also to enable the first end 140 to serve as a vent. The first end 140 may also have a substantially circular shape to provide effective venting. The first end 140 may be entirely outside the flap 134 so that the flap 134 will not interfere with venting of inflation gas through the first end 140. A second end 142 may be disposed underneath the flap 134, and may be narrow enough to form a slit, like the central portion 138.

The venting capability of the first end 140 may enable the vents 60 to be omitted entirely. Hence, the width 141 of the first end 140 may be sufficient to provide an airflow area approximately equal to the combined flow areas of the holes 66 of the vents. For example, the width 141 may be about forty millimeters. Thus, the first end 140 may provide a flow area of about 1250 square millimeters, while each hole 66 of the vents 60 has a diameter of about thirty millimeters, for a combined flow area of about 1400 square millimeters.

The elongated opening 132 may have a length 144 sufficient to permit passage of the inflator 22 through the elongated opening 132. As with the previous embodiment, the length 144 may be about 110 millimeters. Due to the fact that the elongated opening 132 is not fully covered by the flap 134, no overlap may be present. Rather, the elongated opening 132 has an offset 146 equivalent to the length of the elongated opening 132 that protrudes from underneath the flap 134.

As shown, only the circular shape of the first end 140 protrudes from underneath the flap 134. Hence, the offset 146 may be approximately equal to the width 141 of the first end 140. However, in alternative embodiment, the flap 134 may cover more or less than the circular shape of the first end 140; hence, the offset 146 may not be the same as the width 141.

As with the elongated opening 72 of FIG. 3, the elongated opening 132 may be disposed generally along the radius 78 for enhanced tear propagation resistance. The elongated opening 132 may alternatively have an orientation non-parallel to the radius 78, like that of the elongated opening 112 of FIG. 4. The inflator 22 may be inserted through the inflator insertion portion 130 in much the same manner as with the inflator insertion portion 70. The flap 134 may have a width 148 that provides the desired amount of inflator maneuvering room within the pocket created by attachment of the flap 134 to the second panel 26. Additionally, the flap 134 may have a height 149 selected to provide the desired degree of coverage of the elongated opening 132. The width 148 may be about 160 millimeters, while the height 149 may be about 100 millimeters.

Referring to FIG. 6, a plan view illustrates another embodiment of an inflator insertion portion 150 that may be used for the cushion 20, or for an airbag cushion with a different configuration. The inflator insertion portion 150 may have an elongated opening 152. Like the elongated opening 132, the elongated opening 152 provides venting in addition to inflator installation capability. The elongated opening 152 may be partially covered by a flap 154, which is attached to the second panel 26 by attachment lines 156.

The elongated opening 152 may have a central portion 158 disposed underneath the flap 154. The central portion 158 may have a width 159 small enough to form a slit. Furthermore, the elongated opening 152 may have a first end 160 with a width 161, and a second end 162 with a width 163. Each of the first and second ends 160, 162 may have a generally circular shape, and each may be disposed outside the flap 154.

The first and second ends 160, 162 may cooperate to provide airflow area for venting. Thus, like the first end 140 of the previous embodiment, the first and second ends 160, 162 may effectively replace the vents 60. In order to provide about the same airflow area as the vents 60, the first and second ends 160, 162 may each be sized about the same as the holes 66 of the vents 60, i.e., about thirty millimeters in diameter. Thus, the widths 161, 163 may each be about thirty millimeters.

The elongated opening 152 may have a length 164 that is somewhat greater than those of the previously disclosed elongated openings 72, 112, 132. More particularly, the central portion 158 intersects the attachment lines 156 of the flap 154. Hence, the entire length 164 of the elongated opening 152 may not be able to open to receive the inflator 22. Rather, only an insertion length 165, disposed between the attachment lines 156 that intersect the central portion 158, may be available for inflator insertion.

Hence, the insertion length 165 may be long enough to receive the inflator 22, and may thus be about 110 millimeters in length. The length 164 of the entire elongated opening 152 may include the insertion length 165 as well as the widths 161, 163 of the first and second ends 160, 162. Hence, the length 164 of the elongated opening 152 may be about 190 millimeters.

The first and second ends 160, 162 may protrude from underneath the flap 154 by offsets 166, 167, respectively, that are generally equal to the widths 161, 163 of the first and second ends 160, 162. Of course, somewhat larger or smaller offsets 166, 167 may be used if the first and second ends 160, 162 are to be partially covered, or if the central portion 158 is to be partially exposed.

The inflator 22 may be inserted through the central portion 158 of the elongated opening 152 and moved out of the pocket created by the flap 154 and the second panel 26 with one continuous motion. The inflator 22 may then be moved into alignment with the inflator attachment aperture 84 and anchored in place. The flap 154 may have a width 168 sufficient to substantially seal the central portion 158 during deployment of the cushion 20; the width 168 may be about eighty millimeters. The flap 154 may also have a height 169 slightly larger than the insertion length 165; the height 169 may be about 130 millimeters.

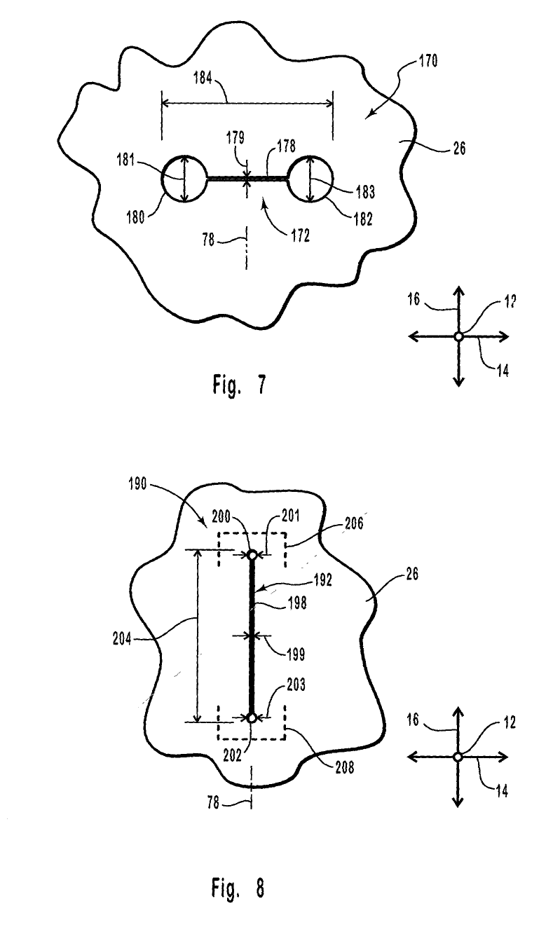

Referring to FIG. 7, a plan view depicts another alternative embodiment of an inflator insertion portion 170 according to the present invention. As with the previous two embodiments, the inflator insertion portion 170 may have an elongated opening 172 that provides for passage of the inflator 22 into the cushion 20 as well as airflow area for venting. However, the elongated opening 172 may not be covered by any type of flap. Rather, the elongated opening 172, in its entirety, may serve as a vent.

The elongated opening 172 may have a central portion 178 with a width 179 narrow enough to form a slit. The elongated opening 172 may have a first end 180 with a width 181 and a second end 182 with a width 183. The widths 181, 183 of the first and second ends 180, 182 may be somewhat larger than the width 179 of the central portion 178.

More specifically, the first and second ends 180, 182 may each have a circular shape large enough to provide venting. For example, as with the previous embodiment, the widths 181, 183 may each be approximately equal to the diameter of each hole 66 of the vents 60, so that the first and second ends 180, 182 are able to replace the vents 60. Hence, each of the widths 181, 183 may be about thirty millimeters.

The central portion 178 may also be expected to open somewhat during deployment to release gas. If desired, the widths 181, 183 may be decreased to compensate for the increased airflow area provided by opening of the central portion 178. The narrow width 179 of the central portion 178 may restrict gas flow through the central portion 178 enough to make a cover flap unnecessary.

The elongated opening 172 may have a length 184 large enough to permit passage of the inflator 22 through the elongated opening 172. Hence, as with some of the previous embodiments, the elongated opening 172 may be about 110 millimeters. As shown, the elongated opening 172 may be oriented generally perpendicular to the radius 78. Although such an orientation is not generally favorable for tear propagation from the first and second ends 180, 182, the large widths 181, 183 of the first and second ends 180, 182 serve as deterrents to tear propagation. Hence, the elongated opening 172 may not pose a significant risk of damage to the cushion 20, despite its orientation perpendicular to the radius 78. Of course, the orientation of the elongated opening 172 may be altered so that the elongated opening 172 is parallel to the radius 78 or disposed at some other non-perpendicular, non-parallel angle, like that of the elongated opening 112 of FIG. 4.

The insertion pathway (not shown) of the inflator 22 may be simplified for the inflator insertion portion 170 of FIG. 7. More specifically, the inflator 22 may be inserted through the elongated opening 172 and moved into alignment with the inflator attachment aperture 84 with one single, generally linear motion. Since no flap is used, the inflator 22 need not be moved out from any pocket within the cushion 20. Hence, installation of the inflator 22 may be facilitated by the configuration of the inflator insertion portion 170.

Referring to FIG. 8, a plan view shows still another embodiment of an inflator insertion portion 190 according to the invention. As with the previous three embodiments, the inflator insertion portion 190 may have an elongated opening 192 that serves two purposes. The elongated opening 192 may permit passage of the inflator 22 into the cushion 20 and to vent measured quantities of pressurized gas from the cushion 20 during deployment and/or impact of the vehicle occupant against the cushion 20.

As shown, the elongated opening 192 may have a central portion 198 with a small width 199, so that the central portion 198 comprises a slit. The elongated opening 192 may also have a first end 200 with a width 201 and a second end 202 with a width 203. The widths 201, 203 of the first and second ends 200, 202 may be larger than the width 199 of the central portion 198. More specifically, the widths 201, 203 may be large enough to restrict tear propagation from the first and second ends 200, 202, but not large enough to provide sufficient airflow area for venting through the first and second ends 200, 202. For example, the widths 201, 203 may each be about five to ten millimeters.

Rather, the majority of the venting may occur through the central portion 198, which may open significantly during deployment of the cushion 20. The elongated opening 192 may have a length 204 sufficient to receive the inflator 22; as with several of the previous embodiments, the length 204 may be about 110 millimeters. The central portion 192 may include most of the length 204, and may thus open significantly in response to the pressure increase within the cushion 20 to release gas.

The central portion 192 may be structured such that, under the pressure within the cushion 20, the central portion 192 opens to provide approximately the same airflow area as the vents 60. Hence, the elongated opening 192 may be used in place of the vents 60. Of course, the elongated opening 192 also receives the inflator 22. More specifically, the inflator 22 may be inserted through the elongated opening 192 in a direction generally perpendicular to the radius 78, and then moved generally along the radius 78, into alignment with the inflator attachment aperture 84. Again, the absence of a flap simplifies the insertion pathway for the inflator 22.

The elongated opening 192 is oriented generally along the radius 78 to reduce the possibility of tear propagation from the first and second ends 200, 202. Additionally, despite their small size by comparison with some of the previous embodiments, the generally circular shape of the first and second ends 200, 202 also provides a deterrent against tear propagation. Furthermore, if desired, first and second reinforcement seams 206, 208 may be disposed to partially encircle each of the first and second ends 200, 202, respectively. More particularly, the reinforcement seams 206, 208 may hold the material outside the first and second ends 200, 202 together, so that the reinforcement seams 206, 208 serve as boundaries beyond which tears are unable to propagate. The reinforcement seams 206, 208 may simply be stitched into place.

Of course, the inflator insertion portions 70, 110, 130, 150, 170, 190 of FIGS. 3 through 8 are simply examples. The inflator design and module requirements may necessitate additional changes to the embodiments shown. Many other inflator insertion portions may be created within the scope of the present invention by combining, isolating, or otherwise modifying the features depicted in the figures.

The airbag modules and associated methods of the present invention present significant improvements in airbag design. Through the use of elongated openings, inflators may be inserted into the airbag cushion after the cushion has been substantially assembled. The elongated opening shapes and/or flap configurations enable the cushions of the present invention to provide reliable sealing and venting of inflation gases. Through the use of radial orientation and/or enlarged opening ends, the probability of tear propagation through the cushion may be minimized.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. An airbag module for protecting occupants of a vehicle from impact, the airbag module comprising:
an inflator configured to produce a quantity of pressurized gas; and
an airbag cushion having an elongated opening with a length selected to permit insertion of the inflator into the airbag cushion through the elongated opening;
wherein at least a portion of the elongated opening forms a slit when the airbag cushion is laid flat.

2. The airbag module of claim 1, wherein the airbag cushion is a front impact airbag cushion having a generally circular shape when laid flat.

3. The airbag module of claim 1, wherein the entire elongated opening has a width of less than about five millimeters.

4. The airbag module of claim 1, wherein the elongated opening comprises a first end and a central portion, the central portion having a width of less than about five millimeters, the first end having a width greater than the width of the central portion.

5. The airbag module of claim 4, wherein the elongated opening further comprises a second end with a width greater than the width of the central portion, the first and second ends each having a generally circular shape with a radius large enough to substantially prevent tear propagation from the first and second ends during deployment of the airbag module.

6. The airbag module of claim 4, wherein the elongated opening further comprises a second end with a width greater than the width of the central portion, the first and second ends each having a generally circular shape with a radius large enough to provide sufficient venting of the airbag cushion during deployment, independent of any other opening in the airbag cushion.

7. The airbag module of claim 1, wherein the airbag cushion further comprises reinforcement stitching disposed proximate the first and second ends to substantially prevent tear propagation from the first and second ends during deployment of the airbag module.

8. The airbag module of claim 1, wherein the width of the elongated opening is small enough that opposite sides of the elongated opening are flush with each other when the airbag cushion is laid flat.

9. The airbag module of claim 1, wherein the elongated opening has a length ranging from about 70 millimeters to about 200 millimeters.

10. The airbag module of claim 1, further comprising a tether attached to opposite portions of the airbag cushion to limit expansion of the airbag cushion toward an occupant of the vehicle.

11. The airbag module of claim 1, further comprising a flap attached to the airbag cushion to cover at least a portion of the elongated opening.

12. The airbag module of claim 11, wherein the flap is disposed inside the elongated opening so that positive gas pressure within the airbag cushion tends to press the flap against the elongated opening.

13. The airbag module of claim 12, wherein the flap covers the entire elongated opening.

14. The airbag module of claim 11, wherein the flap is attached on three sides of the elongated opening to form a pocket that at least partially contains the elongated opening.

15. An airbag module for protecting occupants of a vehicle from impact, the airbag module comprising:
an inflator configured to produce a quantity of pressurized gas; and
an airbag cushion having an inflator insertion portion, the inflator insertion portion comprising an elongated opening, the elongated opening having a length selected to permit insertion of the inflator into the airbag cushion through the elongated opening, the inflator insertion portion having a direction of maximum stress along which tensile stress exerted on the inflator insertion portion by deployment of the inflator will be the largest;
wherein the elongated opening is oriented substantially parallel to the direction of maximum stress.

16. The airbag module of claim 15, wherein the airbag cushion has a generally circular shape when laid flat, wherein the direction of maximum stress is oriented along a radius of the generally circular shape.

17. The airbag module of claim 16, wherein the inflator insertion portion is disposed on a rear panel of the airbag cushion.

18. The airbag module of claim 15, wherein the elongated opening has a width of less than about five millimeters.

19. The airbag module of claim 15, wherein the elongated opening has a first end, a second end, and a central portion, the central portion having a width of less than about five millimeters, the first and second ends each having a generally circular shape with a radius large enough to substantially prevent tear propagation from the first and second ends during deployment of the airbag module.

20. The airbag module of claim 15, wherein the elongated opening has a length ranging from about 70 millimeters to about 200 millimeters.

21. The airbag module of claim 15, further comprising a tether attached to opposite portions of the airbag cushion to limit expansion of the airbag cushion toward an occupant of the vehicle.

22. The airbag module of claim 15, further comprising a flap attached to the airbag cushion to cover at least a portion of the elongated opening.

23. The airbag module of claim 22, wherein the flap is disposed inside the elongated opening so that positive gas pressure within the airbag cushion tends to press the flap against the elongated opening.

24. The airbag module of claim 23, wherein the flap covers the entire elongated opening.

25. The airbag module of claim 22, wherein the flap is attached on three sides of the elongated opening to form a pocket that at least partially contains the elongated opening.

26. An airbag cushion for an airbag module for protecting occupants of a vehicle from impact, the airbag cushion comprising:
a first panel;
a second panel attached to the first panel such that pressurized gas can be retained between the first and second panels, the second panel having an elongated opening with a length selected to permit insertion of an inflator into the airbag cushion through the elongated opening; and
a flap attached to the second panel on at least three sides of the elongated opening to form a pocket that at least partially contains the elongated opening to limit pressurized gas flow out of the airbag cushion through the elongated opening.

27. The airbag cushion of claim 26, wherein the first and second panels comprise front and rear panels, respectively, wherein the front panel is configured to receive forward impact of an occupant of the vehicle.

28. The airbag cushion of claim 27, wherein the front and rear panels each have a generally circular shape, wherein the elongated opening is disposed along a radius of the generally circular shape.

29. The airbag cushion of claim 26, wherein the elongated opening has a width of less than about five millimeters.

30. The airbag cushion of claim 26, wherein the elongated opening has a first end, a second end, and a central portion, the central portion having a width of less than about five millimeters, the first and second ends each having a generally circular shape with a radius large enough to substantially prevent tear propagation from the first and second ends during deployment of the airbag module.

31. The airbag cushion of claim 26, wherein the elongated opening has a length ranging from about 70 millimeters to about 200 millimeters.

32. The airbag cushion of claim 26, further comprising a tether attached to the first panel and to the second panel to limit extension of the first panel toward an occupant of the vehicle.

33. The airbag module of claim 26, wherein the flap is disposed inside the elongated opening so that positive gas pressure within the airbag cushion tends to press the flap against the elongated opening.

34. The airbag module of claim 33, wherein the flap covers the entire elongated opening.

35. The airbag module of claim 33, wherein the flap is attached on three sides of the elongated opening to form a pocket that at least partially contains the elongated opening.

36. A panel for an airbag cushion of an airbag module for protecting occupants of a vehicle from impact, the panel comprising:
an outer edge having a substantially circular shape;
an inflator attachment aperture disposed proximate the center;
an elongated opening having a length selected to permit insertion of the inflator through the elongated opening; and
wherein the opening has an orientation selected to avoid perpendicular intersection of the opening with any radius of the circular shape.

37. The panel of claim 36, wherein the elongated opening is at least partially covered by a flap attached to the panel on three sides of at least a portion of the elongated opening.

38. The panel of claim 37, wherein the elongated opening is fully covered by the flap.

39. The panel of claim 36, wherein the elongated opening has a width of less than about five millimeters.

40. The panel of claim 36, wherein the elongated opening has a first end, a second end, and a central portion, the central portion having a width of less than about five millimeters, the first and second ends each having a generally circular shape with a radius large enough to substantially prevent tear propagation from the first and second ends during deployment of the airbag module.

41. The panel of claim 36, wherein the elongated opening has a length ranging from about 70 millimeters to about 200 millimeters.

42. A method for manufacturing an airbag module for protecting occupants of a vehicle from impact, the method comprising:
forming a panel with an inflator attachment aperture and an inflator insertion portion;
creating an elongated opening in the inflator insertion portion, wherein the elongated opening is substantially parallel to a radius extending outward from the inflator attachment aperture and passing near the elongated opening; and
inserting an inflator through the elongated opening.

43. The method of claim 42, wherein the panel comprises a rear panel for a front impact airbag cushion capable of retaining pressurized gas, the method further comprising:
forming a front panel; and
attaching an edge of the front panel to an edge of the rear panel to form the front impact airbag cushion.

44. The method of claim 43, further comprising creating a vent in the rear panel, separate from the elongated opening, to permit pressurized gas to escape from the front impact airbag cushion at a desired flow rate.

45. The method of claim 44, further comprising:
forming a flap of a fabric material; and
attaching the flap to the rear panel on three sides of the elongated opening to form a pocket that at least partially contains the elongated opening.

46. The method of claim 45, further comprising:
attaching a first tether portion to the front panel;
attaching a second tether portion to the rear panel;
attaching the first tether portion to the second tether portion; and
turning the front impact airbag cushion inside-out so that the first and second tether portions and the flap are disposed inside the front impact airbag cushion.

47. The method of claim 46, further comprising shutting an insertion passageway disposed between the front and rear panels to substantially prevent pressurized gas flow out of the front impact airbag cushion between the edges of the front and rear panels.

48. A method for installing an inflator in an airbag cushion of an airbag module for protecting occupants of a vehicle from impact, the airbag cushion comprising an inflator attachment aperture and an elongated opening with a flap attached inside the elongated opening and on three sides of the elongated opening to form a pocket that at least partially contains the elongated opening, the method comprising:
deforming material around the elongated opening to widen the elongated opening;
inserting the inflator through the elongated opening and into the pocket;
moving the inflator generally away from the inflator attachment aperture to remove the inflator from the pocket; and
seating the inflator within the inflator attachment aperture.

49. The method of claim 48, further comprising disposing the inflator between first and second tether portions attached to opposite portions of the airbag cushion to align the inflator with the inflator attachment aperture.

50. The method of claim 48, wherein seating the inflator within the inflator attachment aperture comprises inserting a projection of the inflator through the inflator attachment aperture to protrude out of the airbag cushion.

51. The method of claim 48, wherein inserting the inflator through the elongated opening comprises inserting the inflator in a direction generally perpendicular to a radius extending from the inflator attachment aperture to the elongated opening.
